(19) United States
(12) Patent Application Publication
(10) Pub. No.: US 2010/0031094 A1
(43) Pub. Date: Feb. 4, 2010

(54) DISK DEVICE, CIRCUIT BOARD, AND ERROR LOG INFORMATION RECORDING METHOD

(75) Inventor: Yutaka Komagome, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/490,929

(22) Filed: Jun. 24, 2009

(30) Foreign Application Priority Data
Jul. 30, 2008 (JP) 2008-196844

(51) Int. Cl. G06F 11/07

(52) U.S. Cl. 714/48; 714/E11.025

(57) ABSTRACT

The disk device includes a disk medium that records data, a non-volatile memory having a first program code region that records a first program code for initial startup, a second program code region that records a second program code, a log information region that records log information, and an error log information record start address that is set in the second program code region; and a processor that operates in accordance with the first and second program codes, collects error log information, and records the collected error log information by overwriting data from the error log information record start address of the non-volatile memory, if the collected error log information cannot be recorded on the disk medium and cannot be expressed with a recordable size in the log information region of the non-volatile memory.

### CROSS-REFERENCE TO RELATED APPLICATION

This application is based upon and claims the benefit of priority of the prior Japanese Patent Application No. 2008-196844, filed on Jul. 30, 2008, the entire contents of which are incorporated herein by reference.

### FIELD

Certain aspects of the embodiments discussed herein are related to a disk device, circuit board, and error log information recording method.

### BACKGROUND

When a fault has occurred in a magnetic disk device using a spinning magnetic disk medium to record information, it is preferable to accurately analyze the cause on the fault and take appropriate measures to prevent the same type of fault from occurring again. Therefore, magnetic disk devices have the functions of collecting and recording error log information of prior running states including the states at the occurrence of faults. The capacity and performance of magnetic disk devices in recent years have greatly increased. Along with this, the types of faults generated have also become more diverse. Accordingly, it is preferable to collect information for each type of these diverse faults as log information.

When a disk device is connected to a host system, the host system can collect the log information. However, if the disk device breaks down, it is preferable to cut it off from the host system and connect it to a fault diagnosis system so as to be able to refer to the log information. In the past, accordingly, error log information has been saved in a non-volatile memory region of the magnetic disk device so that the error log information can be referred to even if the disk device is connected to a diagnosis system. Specifically, the error log information is recorded in the system region of a magnetic disk medium or the log region of a flash ROM (EEPROM: electrically erasable programmable read only memory) on a printed circuit board.

If the error log information is recorded in the disk medium, a large amount of error log information can be recorded, so this is favorable. However, there are cases when the error log information is unable to be recorded on the disk medium. For example, when the drive motor for the disk medium is not operating or the drive motor is operating abnormally, the log information may not be recorded on the disk medium. Further, the log information may not be recorded on the disk medium when the disk medium is not ready, that is, when the preparations for reading/writing are not finished such as in cases when the disk medium has not achieved steady spinning. Further, there are cases when the writing of log information on the disk medium fails even when the disk medium is spinning steadily. For example, if there is internal trouble such as faulty components or mechanical malfunctions in the disk device, the log information may not be written. Further, there are cases when writing of error log information has failed due to vibration of the system housing in which the magnetic disk device is assembled.

It is possible to record the log information with stability if the error log information is recorded in a flash ROM as it has no mechanical parts for writing/reading information. However, the size of the region allocated for log information in a flash ROM is limited, so there is a limit to the error log information that can be recorded.

Accordingly, if the error log information reaches a somewhat large size, it will not fit in the log information region of the flash ROM. Further, when a plurality of related faults occur simultaneously or when faults occur continuously, it is preferable to accumulate log information for each fault, requiring an even larger log information region.

At the present, if error log information having a large size is not recorded on the disk medium for some reason, the error log information cannot be recorded in a flash ROM either, thus the error log information will need to be discarded.

It is known to repair loss of log information due to faults in an auxiliary storage system. In this known method, when storage of the log information in the auxiliary storage system becomes impossible, the log information is stored in the non-volatile memory and when the auxiliary storage system recovers from the fault, the log information is then once again stored in the auxiliary storage system. See Japanese Laid-Open Patent Publication No. 7-319741.

### SUMMARY

According to an aspect of the invention, the disk device includes a disk medium that records data, a non-volatile memory having a first program code region that records a first program code for initial startup, a second program code region that records a second program code, a log information region that records log information, and an error log information record start address that is set in the second program code region; and a processor that operates in accordance with the first and second program codes, collects error log information, and records the collected error log information by overwriting data from the error log information record start address of the non-volatile memory, if the collected error log information cannot be recorded in the disk medium and cannot be expressed with a recordable size in the log information region of the non-volatile memory.

According to an aspect of the invention, a circuit board for a magnetic disk device having a disk medium includes a non-volatile memory having a first program code region that records a first program code for initial startup, a second program code region that records a second program code, a log information region that records log information, and an error log information record start address that is set in the second program code region; and a processor that operates in accordance with the first and second program codes, collects error log information when an error has occurred and, records the collected error log information by overwriting data from the error log record start address set in the second program code record region of the non-volatile memory, if the collected error log information cannot be recorded in the disk medium and cannot be expressed with a recordable size in the log information region of the non-volatile memory.

According to an aspect of the invention, an error log information recording method of a disk device, the disk device including a disk medium that records data, a non-volatile memory including a first program code region that records first program codes for initial startup, a second program code record region that records second program codes, an error log information record region that records the log information, and a processor that operates in accordance with the first and second program codes, the method comprising: having a processor collect error log information, having the processor determine whether or not the collected error log information can be recorded in a system region of a disk medium, having the processor determine whether or not the collected error log information can be expressed with a recordable size in a log information record region of a non-volatile memory, and having the processor record the collected error log information by overwriting data in a second program code record region of the non-volatile memory, if it is determined by the processor that the error log information cannot be recorded in the system data region of the disk medium and cannot be expressed with a recordable size in the log information record region of the non-volatile memory.

The object and advantages of the aspects will be realized and attained by means of the components and combinations of the same particularly pointed out in the claims.

It is to be understood that both the foregoing general description and the following detailed description are exemplary and explanatory and are not restrictive of the invention, as claimed.

### BRIEF DESCRIPTION OF THE DRAWINGS

These and other objects and features of the present invention will become clearer from the following description of a preferred embodiment given with reference to the attached drawings, wherein:

FIG. 1 is a view depicting an example of a magnetic disk device in which the present embodiment is used;

FIG. 2 is a view explaining a control unit of the magnetic disk device of the present embodiment;

FIG. 3 is a view depicting an example of the storage region of a non-volatile memory;

FIG. 4 is a view depicting a flow of write processing of error log information according to the present embodiment;

FIG. 5 is a view depicting a magnetic disk device connected to a fault diagnosis system according to the present embodiment; and

FIG. 6 is a view depicting a flow of a process for reading error log information from a magnetic disk device according to the present embodiment.

### DESCRIPTIONS OF EMBODIMENTS

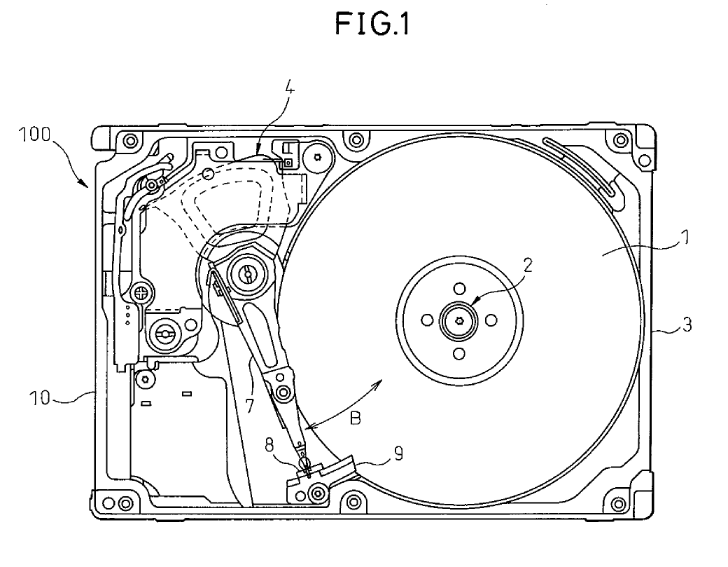

FIG. 1 is a view depicting in brief mechanical parts of a magnetic disk device to which an embodiment is applied. A magnetic recording medium of a magnetic disk device 100, that is, a magnetic disk 1, is rotatably supported at a spindle motor 3 fixed to a disk enclosure 1. A magnetic head 8 writing/reading information is arranged at a front end of an actuator 7 so as to face the magnetic disk 1. The actuator 7 is fixed to a disk enclosure 3 so as to be able to move in a substantially radial direction B of the magnetic disk 1 by a voice coil 4. The magnetic head 8 is held by a ramp 9 when it is retracted from the magnetic disk 1. The control unit 10 comprises a plurality of integrated circuits mounted on a printed circuit board and controls various operations such as the spinning of the magnetic disk 1, the seek operation of the magnetic head 8, or the writing/reading of information by the magnetic head.

The present embodiment covers disk devices using magnetic disks, but may also be used for disk devices using opto-magnetic disks, optical disks, and other disk media.

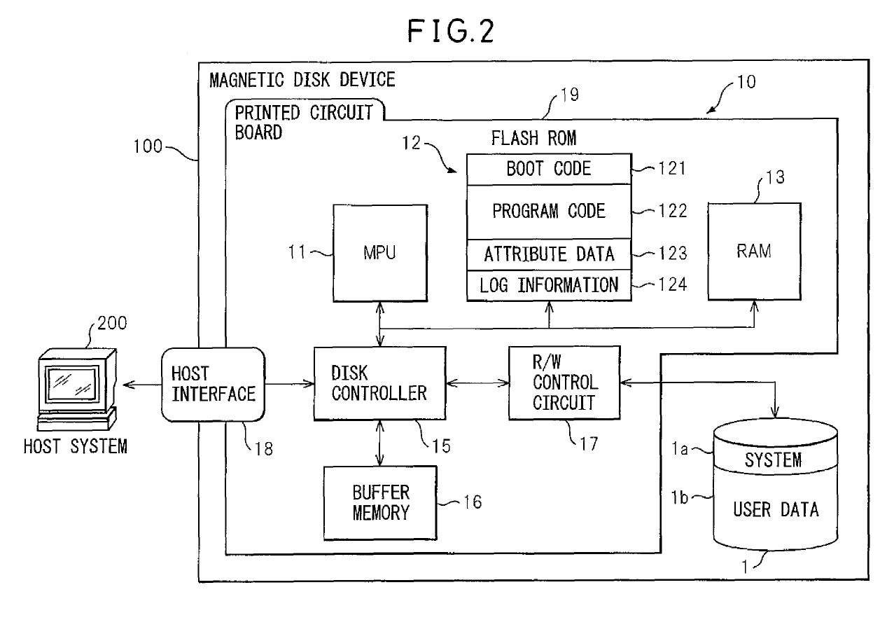

FIG. 2 is a schematic view depicting a control unit of a magnetic disk device of one embodiment. In FIG. 2, function blocks relating to the recording of error log information are depicted for explaining the present embodiment. Functions not necessary for explaining the present embodiment such as control of the spinning of the disk medium 1 or control of the head for writing/reading of the disk medium 1 have been omitted or simplified.

The magnetic disk device 100 is provided with a magnetic disk 1 and a control unit 10 mounted on a printed circuit board 19. The control unit 10 is connected through a host interface 18 to a server or a PC (Personal Computer) or other host system 200.

The disk medium 1 has a system region 1a and a user data region 1b. The system region 1a is a region for recording program codes which could not be stored in a flash ROM (Read Only Memory) 12, device-specific attribute data, and log information. The user data region 1b is a region for recording data which can be read/written by a user using the host system 200.

The control unit 10 is formed by a plurality of circuit components such as LSIs (Large Scale Integration) mounted on the printed circuit board 19. An MPU (Micro Processing Unit) 11 is operated according to a program loaded in a RAM (random access memory) 13. Accordingly, the MPU 11 controls the collection and recording of the error log information.

The flash ROM 12 is a rewritable non-volatile semiconductor memory in which programs and data for the MPU 11 are stored. The regions of the flash ROM 12 include a boot code region 121, a program code region 122, an attribute data region 123, and a log information region 124. The boot code region 121 stores program codes executed for initial startup of the MPU 11. The program code region 122 stores program codes for operating the MPU 11 after the boot codes. The program code region 122 stores program codes for making the MPU 11 operate until the magnetic disk medium 1 at least reaches the ready state. The attribute data region 123 stores attribute data and control data specific to this magnetic disk device. The log information region 124 is used for recording small log information.

The program codes are loaded into the RAM 13 from the flash ROM 12 and the system region 1a of the disk medium 1. The MPU 11 operates in accordance with the program loaded into the RAM 13.

The disk controller 15 controls the transmission and reception of commands and data between MPU 11 and each of the host interface 18 and a read/write (R/W) control circuit 17. The R/W control circuit 17 controls the writing/reading of data to the disk medium 1. A buffer memory 16 operates as a cache for enabling the magnetic disk device 100 to efficiently output data.

The magnetic disk device 100 has a portion of the system region 1a on the disk medium 1 and a log information region 124 which is a portion of the flash ROM 12 to record error log information. As one example, the system region 1a on the disk medium 1 is 9 MB. Of the 9 MB of the system region 1a, 1 MB may be allocated as for the program codes, and 4.5 MB as for the attribute data. If so, 3.5 MB of the system region 1a may be used for recording the log information.

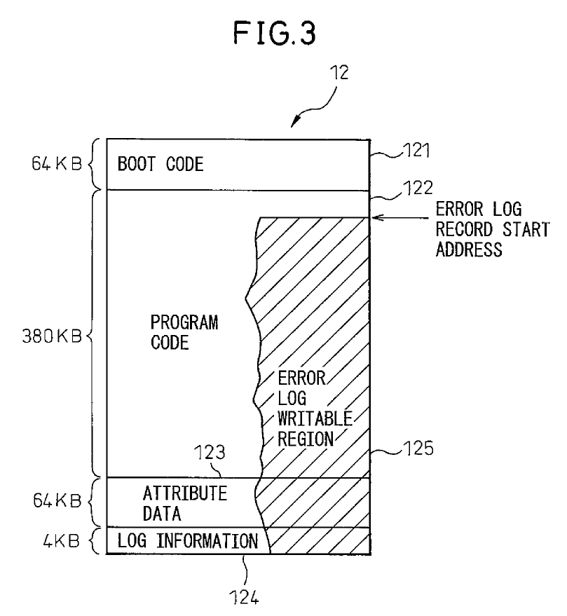

FIG. 3 depicts an example of the flash ROM 12 used in the magnetic disk device 100 of the present embodiment. In this example, the capacity of the flash ROM 12 is 512 kB. The capacity of the boot code region 121 storing the boot codes is 64 kB. The capacity of the program code region 122 storing the program codes for the operation of the MPU 11 after the initial operation is approximately 380 kB. The capacity of the attribute data region 123 is 64 kB. Accordingly, the capacity of the log information region 124 is approximately 4 kB.

In the present embodiment, an error log information writable region 125 is defined in the flash ROM 12 in order to record large log information which cannot be stored in the log information region 124. Specifically, a write start address for error log recording is defined in the program code region 122. The error log information is written in order from the write start address. In FIG. 3, the error log information writable region 125 extends over the program code region 122, attribute data region 123, and log information region 124.

If the error log information is written in the error log information writable region 125, the program codes will be overwritten, thereby destroying the program codes. Accordingly, the error log information writable region 125 is set so as to not include the program codes for initial startup, that is, the boot codes. As long as the error log information writable region 125 is set so as not to include the boot code region 121, it is possible to arbitrarily set a start address and an end address of the error log information writable region 125. The error log information writable region 125 may be set taking into consideration the assumed size of the error log. Further, the error log information writable region 125 may be set so that a portion of the program codes of the program code region 122 and/or a portion of the attribute data of the attribute data region 123 are not overwritten.

The error log information includes statistical information including the number of and rate of occurrence of faults, historical information including the order of occurrence of faults, and individual information including detailed information relating to individual faults. In particular, augmenting the individual information contributes greatly to determining the cause of the faults. However, augmenting the individual information enlarges the size of the error log information.

For example, a size of the log information necessary for error investigation exceeds 30 KB at the time of occurrence of a buffer CRC error. A buffer CRC is a CRC code for guaranteeing the normality of transmitted data between the host system 200 and the disk medium 1 through a buffer memory 16. When an error is detected in the CRC code during data transmission, the possibility of a fault occurring in the buffer memory 16 is high. However, there is also the possibility of trouble occurring in the components between the R/W control circuit 17 and the host interface 18 or trouble occurring on the data bus. As the amount of information necessary for identifying this fault state, first approximately 28 kB is required for control information on the program (internal table, register value, internal processing sequence history) upon detection of an anomaly. Further, approximately 5 kB to 10 kB is required for the dump data in the vicinity of an error occurrence point estimated in the buffer memory 16. This dump data is equivalent to approximately 10 to 20 sectors when 1 sector is 512 bytes. The total amount of information required is approximately 33 to 38 kB.

Error log information having a size exceeding 30 kB cannot fit in the log information region 124 since the log information region 124 of the flash ROM 12 is approximately 4 kB. The log information may be stored in the system region 1a of the disk medium 1. However, there are cases where the log information cannot be recorded in the system region 1a of the disk medium 1 or recording the log information fails.

When the error log information is not recorded in the disk medium 1 and the log information region of the flash ROM, the error log information is recorded in the error log information writable region 125. That is, the error log information overwrites data from the log record start address.

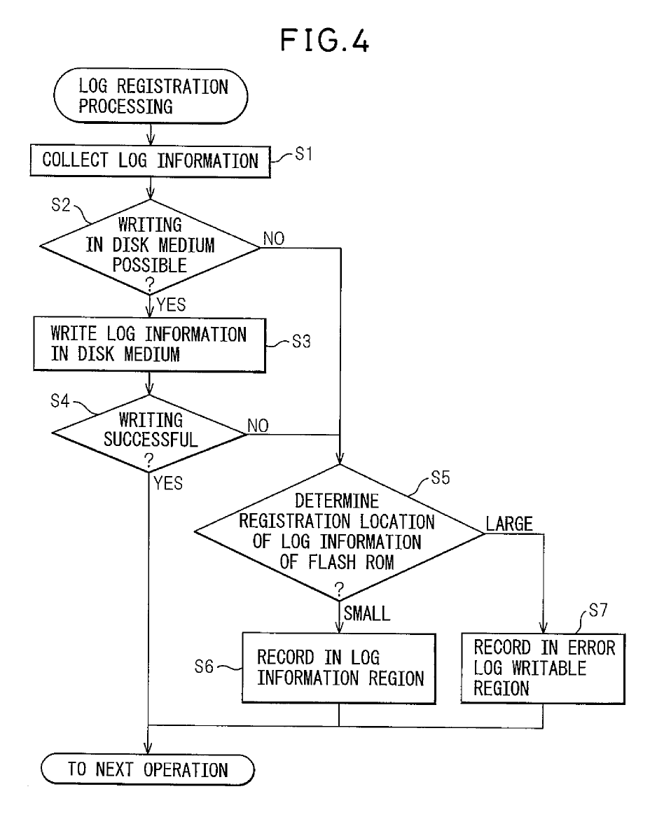

FIG. 4 is a view depicting the flow of the recording operation of error log information according to the present embodiment. If a fault or other phenomenon occurs, log registration processing is performed. First, the MPU 11 collects log information and stores it in the work region of the RAM 13 (S1).

Next, the MPU 11 confirms if writing in the system region 1a of the disk medium 1 is possible (S2). That is, it is checked if the disk is properly spinning or if there is any trouble in the mechanical parts.

If it is determined at step S2 that the system region 1a of the disk medium 1 is in a writable state, the log information is written in the system region 1a of the disk medium 1 (S3). Next, it is determined if writing in the system region 1a of the disk medium 1 is successful (S4).

If it is determined at step S4 that writing in the system region 1b of the disk medium 1 is successful, the log registration processing ends, and the routine proceeds to the next processing.

If it is determined at step S2 that writing in the system region 1a of the disk medium 1 is not possible, the routine proceeds to step S5. Further, if it is determined at step S4 that writing in the system region 1a has failed such as in a case where write processing of the system region 1a of the disk medium 1 has ended abnormally, the routine proceeds to step S5.

At step S5, it is determined if the collected error log information can be recorded in the log information region 124 of the flash ROM 12. The determination of recordability in the log information region 124 depends on, the importance of the fault that has occurred, the size of the error log information, and whether the error log information can be compressed. Determination standards such as thresholds of the size are defined by the program stored in the flash ROM 12. Even large error log information can be recorded in the log information region 124 by selecting and compressing the necessary error log information. Further, it is not necessarily that large recording error log information is recorded to the extent of destroying the program codes when the importance of the fault is low. If it is determined that recording of an extent of destroying the program codes is not necessary, all of the error log information is discarded without being recorded.

At step S5, when the uncompressed or compressed size of the log information is one that can be stored in the log information region 124 of the flash ROM 12 and the necessary error log information can be expressed, it is determined that the error log information can be recorded in the log information region 124. If it is judged that it can be recorded in the log information region 124, at step S6, the error log information is recorded in the log information region 124, and, when the recording is finished, the error log registration processing is completed.

If the error log information is recorded in the log information region 124, the program codes will remain as they are in the program code region 122 of the flash ROM 12, therefore when the power is shut off and then turned on, the device will start up normally.

When the size of the necessary error log information exceeds the size of the log information region 124 even if the collected error log information is compressed, the error log information cannot be stored in the log information region 124. Accordingly, at step S5, it is determined that the large error log information that cannot be stored in the log information region 124 is recorded in the error log information writable region. Accordingly, at step S7, the error log information overwrites data from the log record start address of the error log information writable region 125. When the writing of the error log information to the error log information writable region ends, the log registration processing is completed.

When the error log information is written in the error log information writable region, the program code of the program code region 122 of the flash ROM 12 is destroyed, and the magnetic disk device 100 will not start up normally when the power is shut off and then turned on.

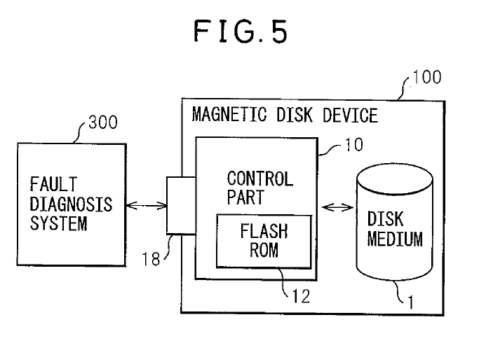

FIG. 5 is a view depicting a magnetic disk device connected to a fault diagnosis system. A magnetic disk device 100 in which a fault has occurred is cut off from the host system 200 and connected to the fault diagnosis system 300, whereby fault analysis and check are performed. The fault diagnosis system 300 may be a server or PC similar to the host system. The fault diagnosis system 300 is connected through the host interface 18 to the control unit 10. The fault diagnosis system 300 collects the error log information recorded in the disk medium 1 or error log information recorded in the flash ROM 12 of the control unit 10 and saves the error log information as a file in the fault diagnosis system 300. The fault diagnosis system 300 performs a log check based on the error log information saved in the file.

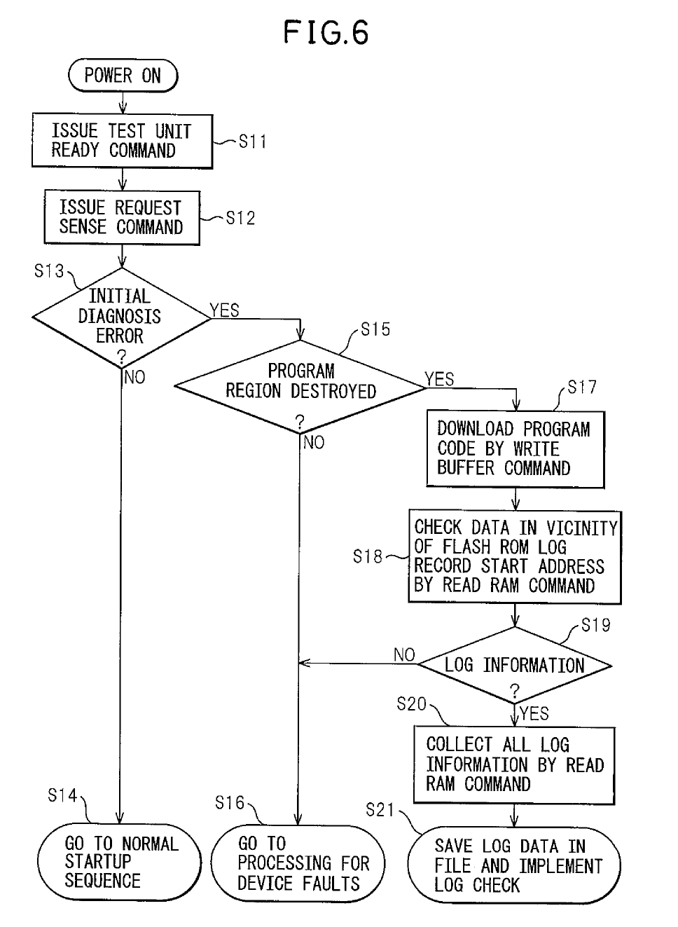

FIG. 6 is a view depicting an example of the steps of collecting the error log information by starting up the magnetic disk device connected to the fault diagnosis system. In FIG. 6, the explanation is given based on host interface commands conforming to SCSI (Small Computer System Interface) standards. However, the flow of FIG. 6 by similar processing is possible even with interface commands according to other standards.

The disk device 100 in which the fault has occurred is cut off from the host system 200 and connected to the fault diagnosis system 300. The fault diagnosis system 300 activates the disk device 100 and issues a TEST UNIT READY command to the magnetic disk device 100 in order to confirm the state of the disk device 100 (S11). Since the magnetic disk device 100 has still not been started up and is in a not ready state, even if the magnetic disk device 100 is normal, the TEST UNIT READY command terminates with error.

Also, the fault diagnosis system 300 issues a REQUEST SENSE command for discovering the details of the error and collects sense information (S12). It is determined if the collected sense information shows initial diagnosis error (S13). When the sense information does not show initial diagnosis error, the routine proceeds to the normal startup sequence because the magnetic disk device 100 is in the normal not ready state (S14).

If it is determined at step S13 that the sense information shows initial diagnosis error, the routine proceeds to step S15, where the category of the initial diagnosis error is identified. If the error log information is recorded in the program region 122 of the flash ROM 12, the program region is destroyed, however, the boot code region 121 is not destroyed. Accordingly, initial operation of the magnetic disk device 100 in accordance with the boot codes is possible. The boot codes have a self-diagnosis function able to diagnose if the program codes are normal and if the basic electronic circuits are normal. Accordingly, if it is detected by the self-diagnosis function of the boot codes that the program codes are invalid, it is understood that the program codes have been destroyed.

If it is judged at step S15 that the program codes are valid, the routine proceeds to step S16, where processing which is performed at the time of a conventional device fault is performed.

At step S15, when the initial diagnosis error is caused by the destruction of the program codes, the routine proceeds to step S17. At step S17, normal or test program codes are downloaded from the fault diagnosis system 300 to the magnetic disk device 100 by the WRITE BUFFER command of an SCSI interface and are loaded in the RAM 13. The program codes from the diagnosis system 300 is downloaded in a mode in which it is not saved in the flash ROM 12, that is, the non-volatile memory (mode=4). It is necessary for the downloaded program codes to support a command (READ RAM command) able to read data from the memory space including the flash ROM 12 in order to read the content of the flash ROM 12.

After downloading is completed, at step S18, the diagnosis system 300 issues the READ RAM command and checks data in the vicinity of the log record start address of the program code region 122 (S18). The log record start address vicinity is the region in which the program codes are normally written. Accordingly, if data to indicate log information, for example, the header of a log or a log pattern, is included in data in the vicinity of the log record start address, it is understood that the error log information has overwritten program data. A specified log pattern clearly showing that it is error log information may be recorded in the vicinity of the log record start address, when the error log information overwrite the program data.

In accordance with the check of data in the vicinity of the log record start address at step S18, at step S19, it is judged if data to indicate log pattern or other log information exists in the vicinity of the log record start address. If data to indicate log information does not exist in data in the vicinity of the log record start address, processing which is performed at the time of a conventional device fault is performed because the program code will not be destroyed.

If data in the vicinity of the log record start address is error log information, at step S20, all the error log information is collected in the fault diagnosis system 300 in accordance with the READ RAM command. Next, at step S21, the fault diagnosis system 300 saves the collected log information in a file inside the fault diagnosis system 300 and implements a log check based on the log information of the saved file.

In the present embodiment, when a fault requiring the recording of a large error log occurs, even if the error log cannot be recorded in the disk medium, the error log is recorded in the non-volatile memory. Accordingly, the error log information is not discarded and is safely recorded. Further, as a result of recording the error log information in the non-volatile memory, even if the program code region of the non-volatile memory is destroyed, the magnetic disk device may be connected to the fault diagnosis system, and the error log information recorded in the non-volatile memory may be extracted.

In other words, even when the error log information cannot be recorded in the disk medium and cannot be expressed with a recordable size in the log information region of the non-volatile memory, it can be recorded in the non-volatile memory. Accordingly, situations in which necessary error log information must be discarded can be avoided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A disk device, comprising:
a disk medium that records data,
a non-volatile memory having a first program code region that records a first program code for initial startup, a second program code region that records a second program code, a log information region that records log information, and an error log information record start address that is set in the second program code region; and
a processor that operates in accordance with the first and second program codes,
collects error log information, and
records the collected error log information by overwriting data from the error log information record start address of the non-volatile memory, if the collected error log information cannot be recorded in the disk medium and cannot be expressed with a recordable size in the log information region of the non-volatile memory.

2. The disk device as set forth in claim 1, wherein a region that records the collected error log information by overwriting data is a region excluding the first program region.

3. A circuit board for a magnetic disk device having a disk medium, comprising:
a non-volatile memory having a first program code region that records a first program code for initial startup, a second program code region that records a second program code, a log information region that records log information, and an error log information record start address that is set in the second program code region; and
a processor that operates in accordance with the first and second program codes,
collects error log information when an error has occurred and,
records the collected error log information by overwriting data from the error log record start address set in the second program code record region of the non-volatile memory, if the collected error log information cannot be recorded in the disk medium and cannot be expressed with a recordable size in the log information region of the non-volatile memory.

4. The disk device as set forth in claim 3, wherein a region that records the collected error log information by overwriting data is a region excluding the first program region.

5. An error log information recording method of a disk device, the disk device comprising,
a disk medium that records data,
a non-volatile memory including a first program code region that records first program codes for initial startup, a second program code record region that records second program codes, an error log information record region that records the log information, and
a processor that operates in accordance with the first and second program codes, the method comprising: having a processor collect error log information,
having the processor determine whether or not the collected error log information can be recorded in a system region of a disk medium,
having the processor determine whether or not the collected error log information can be expressed with a recordable size in a log information record region of a non-volatile memory, and
having the processor record the collected error log information by overwriting data in a second program code record region of the non-volatile memory, if it is determined by the processor that the error log information cannot be recorded in the system data region of the disk medium and cannot be expressed with a recordable size in the log information record region of the non-volatile memory.

6. The error log information recording method as set forth in claim 5, wherein a region that records the collected error log information by overwriting data is a region excluding the first program region.

7. An error log information recording method as set forth in claim 5, further comprising:
connecting a disk device to a fault diagnosis system,
having the fault diagnosis system issue a first command and determine whether or not the second program region is destroyed,
having the fault diagnosis system issue a second command to download a second program code to the disk device,
having the fault diagnosis system issue a third command to check data in the vicinity of the error log information record start address of the second program region, and
having the fault diagnosis system collect all the log information recorded in the non-volatile memory, if it is determined that data in the vicinity of the error log information record start address is log information.
